(19) United States
(12) Patent Application Publication
(10) Pub. No.: US 2003/0104800 A1
(43) Pub. Date: Jun. 5, 2003

(54) Telephone with alarm signalling

(76) Inventor: Artur Zak, Syracuse, NY (US)

Correspondence Address: BERNHARD P. MOLLDREM, JR., 2ND FLOOR, MONROE BUILDING, 333 EAST ONONDAGA STREET, SYRACUSE, NY, 13202, US

(21) Appl. No.: 10/082,543

(22) Filed: Feb. 21, 2002

(30) Foreign Application Priority Data
Nov. 30, 2001 (PL) P 350968

(51) Int. Cl. H04M 11/00; H04M 1/00; H04B 1/38

(52) U.S. Cl. 455/404; 455/564

(57) ABSTRACT

A fully functional telephone set, which may be a standard cord phone, cordless, or wireless (cellular) is equipped with an emergency condition sensor, such as a motion sensor for intrusion detection, and a smoke or fire detection sensor. A single push button arms or disarms the system, with a short time delay. If an emergency condition is detected, the phone dials out to the last number dialed or to some number preset by the user. In the case of fire detection or intrusion detection, an alarm in the telephone instrument is sounded. A silencer switch permits a silent alarm mode for intrusion detection. A sensitive microphone permits monitoring of the protected area from the called station.

### BACKGROUND OF THE INVENTION

The present invention relates to a telephone based alarm system, and is more particularly directed to a telephone set that incorporates motion detection, fire detection, or intrusion detection, or other emergency situation detection, and automatically dials a number preset by the user. The invention is more particularly concerned with a telephone unit that can be employed normally as an ordinary telephone for calling out and for receiving calls, but can also be used to notify a person at another telephone number of an emergency situation, whether or not the user or originating party is present. Favorably, this is accomplished without resort to a third-party monitoring service.

Many techniques for sending alarm conditions by phone line are well known. For example, in U.S. Pat. No. 5,283,816 a smoke detector or fire detector unit has a built-in telephone dial pad, and has a capability of connecting with a phone line and dialing the last number entered by the user. If smoke or fire is detected, the unit uses the phone line to dial the preset number, and then transmit either coded information or a message that has been pre-recorded (e.g., on tape). The smoke detector has no voice capabilities, and cannot be used for an ordinary conversation, nor may the unit be used for receiving phone calls. In addition, the unit of the U.S. Pat. No. 5,283,816 has no provision for detecting other important emergency conditions, such as an intrusion or a burglary.

An emergency bedside telephone alarm and monitoring unit has been proposed in U.S. Pat. No. 6,259,787. In this arrangement, a cordless phone is concealed in some ordinary object, such as a vase or a hollowed-out book, and is connected to an impact switch so that it sill automatically go off-hook and dial some preset number if the patient knocks the object over.

Other common alarm detection systems require special in-home equipment and in the event of an alarm condition the equipment uses the phone line to reach a monitoring station at a preset number. In this case, there is no flexibility as to which telephone number the equipment dials. Furthermore, there is nothing portable about this equipment, and has to be professionally installed and cannot be moved about by the user. This kind of monitoring system requires a monitoring company that demands payment of a monthly fee.

### OBJECTS AND SUMMARY OF THE INVENTION

It is an object to provide a telephone instrument that is capable of monitoring for one or more emergency conditions, and automatically dialing a preset number of the user's choice, and which avoids problems of conventional systems, such as the requirement for a third-party monitoring company.

It is another object to provide an alarm signalling telephone instrument that may be connected to the phone line and uses for making and receiving calls, as would a conventional telephone instrument, but which will automatically dial and connect with a predetermined phone, such as the last number dialed, in the event an emergency condition is detected.

It is a further object to provide an alarm signalling telephone instrument that is capable of providing a local alarm sound to alert any persons present to the fire, break-in, or other emergency, but can be set for silent monitoring to permit police to monitor an event and to arrive and apprehend a possible burglar, for example.

It is a still further object to provide a cellular portable phone that incorporates an emergency condition monitor and means for automatically dialing a preset number, such as last-number-dialed, in the event that an emergency condition is detected, but which can also be used as an ordinary cellular phone to make and receive phone calls or messages.

According to one aspect of the present invention, a telephone instrument, which has a housing, electrical and electronic equipment within the housing, a dial pad, and earpiece and mouthpiece, is also fitted with an alarm detector, e.g., a fire detector, smoke detector, and/or motion detector, and can be provided with a fitting for connecting with one or more external sensors, either by wire or wirelessly. When the detector(s) find an emergency condition is present, then, after a suitable time delay of, e.g., several seconds, the phone instrument initiates dialing to a predetermined number, e.g., last number dialed. Depending on the customer's desires and the nature and capabilities of the equipment, in some cases the instrument can call some preset number regardless of the last number that was dialed, e.g., “911” in case of a break-in or fire. If needed, a sonic alarm, i.e., siren, can be actuated. In the case of a burglary or break-in, the siren can be kept off (silent monitoring) and a highly sensitive microphone can be activated for live-audio monitoring of the activities of the unauthorized person in the protected area.

An external outlet provides the capability of connecting with an additional sensor, which may be in another room. This may be a CO sensor, a flood sensor, room temperature sensor (for furnace or air-conditioning problems), or some other emergency sensor. A “panic button” feature may be provided either on the dial pad of the phone or elsewhere on the housing of the instrument for automatically dialing the last number (or 911) and activating the siren or other sounder. An RF, infrared, or other wireless device may be used for connecting with the alarm sensor or with a panic button. In addition, a voice-recognition chip may be included for recognizing a verbal cry for help and using that to actuate the emergency dial up.

The telephone instrument of this invention is well suited for a self-monitoring program, where programming of information at the receiving end takes place using a key pad, and can be easily reprogrammed at any time. The user may take the telephone instrument with him, e.g., to a hotel or other temporary location to detect emergencies and notify the called party of his choice, which may be his own home or office phone, or that of a family member or neighbor.

An important characteristic of this invention is the provision that permits the alarm sensor(s) to initiate a phone connection with the preset number (last number dialed) stored in its memory. After connection, any alarm information may be automatically transmitted as a form of audio signals, either in some pattern of tones or as audible sounds from the over-sensitive microphone. For example, if a fire is detected, either a steady tone or a pattern such as long-short-short, repeated, which is the letter “F” in Morse code, can let the called party know something about the emergency. If the called party has a Caller ID feature, then the location of the emergency can be identified as well. Otherwise, a prerecorded (or synthetic speech) voice message of “Fire” or “Possible Break In” can be sent to the called party. The live-audio microphone is capable of transmitting phonic signals of sirens or sounds from the protected area. The signals will differ, depending on the sensor that is initiating the call. Because the telephone network has some inertia, i.e., some delay time in making the call, as well as some delay in getting dial tone, there is a small amount of time (usually 3 to 8 seconds) for the person to disarm the system in the case of an inadvertent actuation. There can be a built in delay of e.g. 20 seconds to permit the user to disarm the system, for example when he or she returns home.

The length of time over which the alarm and/or audio information is transmitted can be limited to about three minutes, after which the phone instrument resets and goes back to a ready mode, unless the alarm condition persists. If a fire protection sensor is the one actuated, then a very loud alarm is sounded, as well as dialing the last dialed number (or other preset number). The fire sensor is kept in standby mode at all times. Fire protection alarm is independent from burglar or intruder detection, and is active and does not disarm. Within the enclosure or housing of the instrument there is at least one sensor and at least one outlet for another sensor. Within the enclosure or housing there is a burglar alarm siren connected with an on-off switch which permits the capability of silent monitoring. The fire protection circuitry also has an alarm siren and a time delay relay.

A panic button on the instrument activates the burglar alarm siren if the on-off switch is in the ON position, and automatically initiates a silent monitoring call to the predetermined number if the switch is in the OFF position. This can be manually actuated or can be voice actuated. In the latter case, the panic button feature can include voice recognition circuitry which can be programmed to trigger the system when the user speaks out a special, predetermined phrase, such as “Emergency—I need help”.

The burglar alarm or intrusion alarm detection feature can include an infra-red motion sensor. This sensor is favorably “pet friendly” to exclude false activation by motion of household pets. In parallel to the motion sensor is a “shock sensor” (e.g., mercury switch) used to activate the system if there is an attempt by the intruder to damage the system. This can include a mercury contact switch. The shock sensor has a special fitting if used with a cellular phone to renew alarming status for tracking purposes. This can play a major role if the cell phone unit is used for protection of a vehicle, and makes it possible to locate the stolen vehicle.

Also in the case where the telephone instrument is a cellular phone, the instrument can be equipped with a recharging stand, or with a rechargeable battery backup. In either a wired or wireless phone instrument, there may be status indicators mounted on the housing or enclosure which can be kept on to indicate status, or switched off if silent monitoring is desired.

The apparatus of this invention is characterized in its simplicity, and in its ability to serve as a multi-functional security system. Despite its simplicity, the telephone instrument of this invention can send much more information than can any other available security system. In addition, the instrument is a fully-functional telephone unit, and is operational normally as a normal telephone for making and receiving calls. In addition to sending alarm information, the telephone instrument of this invention can also supply “live audio” from the protected area to the receiving station. The phone instrument is portable, and can be simply connected to an existing phone line, or in the case of a cellular version, can be carried on the person or in a vehicle, or left in a room that is to be protected. In the cellular version, there is the advantage that with no telephone line to cut, the intruder cannot simply defeat the system by using wire cutters. The cellular version also constitutes a personal alarm system capable of automatically dialing for help while emitting a loud aggressor-repellant sonic alarm, and its tracking capabilities make it possible for police or other emergency personnel to find the user quickly. If a motion sensor triggers the alarm or if the panic button is pushed, then there is protection in the form of a loud siren signal and at the same time dialing takes place and provides police or other persons with “live audio” and the approximate location of the emergency event.

The arrangement of this invention is a fully operational telephone instrument, which can be wired or wireless, and is also an alarm system which causes the instrument to connect itself automatically with the last number dialed (or other easily set user-selected number). Emergency sensor(s), as well as alarm siren or sirens are located within the telephone instrument housing or can be remotely located and externally attached. The information about the emergency event that triggers the alarm can be picked up by the ultra-sensitive microphone, and can provide police or fire crews with additional information about the emergency. The microphone picks up the audible siren sounds, but in a silent monitoring mode picks up “live audio” from the protected area. The “panic button” feature actuation can result in a loud alarm sound to repel a burglar or intruder, and to signal to others in the vicinity that a problem exists. The telephone instrument of this invention is ideally suited for “self-monitoring’ of a given area. The programming of the instrument for the type of alarming needed is easily accomplished by the user without any special training.

The above and many other advantages and features of this invention will become apparent from the ensuing description of selected preferred embodiments of the invention.

### BRIEF DESCRIPTION OF THE DRAWING

FIG. 1 is a perspective view of a desk telephone instrument according to one embodiment of this invention.

FIG. 2 is a perspective view of a cellular telephone instrument according to an embodiment of this invention.

FIG. 3 is a block schematic view of the arrangement of this invention illustrating its anti-burglar alarm features.

FIG. 4 is a block schematic view of the arrangement of this invention illustrating its fire-protection alarm features.

FIG. 5 is a block schematic view of the arrangement of this invention illustrating both the above features.

### DETAILED DESCRIPTION OF THE PREFERRED EMBODIMENT(S)

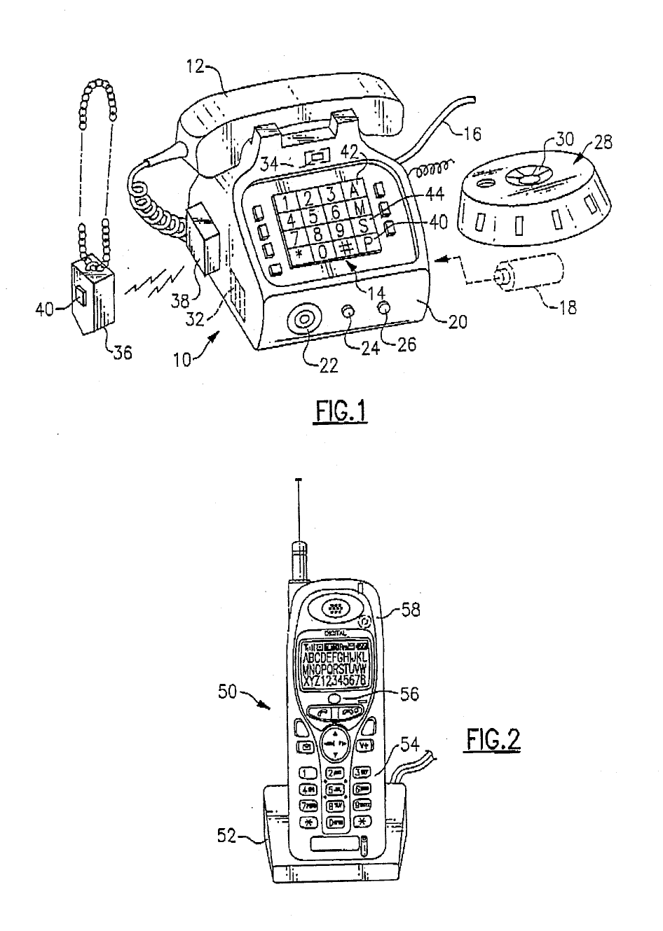

With reference to the Drawing, and initially to FIG. 1 thereof, a telephone instrument 10 according to one embodiment of this invention is a standard, desk-type instrument and is capable of dialing out for making and receiving phone calls, as well as including the sensor and alarm features of the invention. The instrument 10 has a receiver or handset 12, here shown in the cradle, and a dial pad 14, with the usual dial pad keys, one through nine, zero, “star”, “pound” and several special function keys, including redial, hold, etc., plus keys assigned for features to be discussed shortly. The handset 12 has a handle portion, a voice pickup on one end and a speaker or earpiece on the other, as is usual. The function keys can be assigned to one or another function at the option of the manufacturer or the customer. This instrument 10 has a phone cord 16 that connects to an outlet for a wired phone line. The phone instrument has a battery-backup feature, and a 12-volt back-up power cell 18 is illustrated here in ghost line. This cell 18 fits into a standard battery holder in the instrument in a known fashion. The main body or base of the telephone instrument 10 has a casing or housing 20, on a front panel of which are mounted an infrared motion detector 22, as well as a pair of LED status indicators 24 and 26. These indicators can be assigned such status as indicating silent or audible alarm mode, armed or disarmed mode, and/or whether motion has been detected.

In this embodiment, a pet-friendly motion detector 22 is preferred, which will ignore motion below some threshold, and thus not respond to the motion of a dog or cat which may be present in the room.

A fire or smoke detector 28 is here shown as a remote device, which is wire-connected to the instrument 10. In other embodiments, the connection can be made by RF or IR, or by optical fiber. This detector 28 can detect carbon monoxide, heat, smoke, or other factors. Alternatively, or additionally, a detector may be used to detect flooding, unusual cold (i.e., furnace problems), etc. Here the fire or smoke detector 28 incorporates a visible alarm 30, e.g., a flashing strobe, as well as an audible alarm, or may use the audible alarm that is present in the instrument 10.

As illustrated, the body of the instrument may have an alarm sounder 32 inside the housing 20, and a highly sensitive microphone 34, which may be actuated or turned on by the detection of an alarm condition. This provides live audio to a called station, and may carry voices or other noises of intruders, as well as providing an audible pickup of the alarm sounder 32. Alternatively, the ultra-sensitive microphone 34 can be contained in the handset 12.

A remote “panic button” device 36 is here shown as a medallion that can be worn by the user, and is connected wirelessly (e.g., RF or IR) to a receiving device 38 that is mounted on the housing 20 (or is contained within the housing 20). This permits the user to actuate the alarm device remotely, for any of a variety of reasons, and also to actuate the automatic dial feature so that assistance can be obtained. This feature is useful for a disabled, invalid or infirm user, who may need assistance while at some distance from the telephone instrument 10 but within the home. In that case, the ultra-sensitive microphone 34 will permit the user to communicate with a potential rescuer that is dialed up, even if the user is in another room or dozens of feet away from the phone.

There is also a panic button key 40 on the key pad 14, as well as an alarm on/off key 42 (i.e., intrusion alarm arm-disarm key), and an alarm silent/audible key 44.

A second illustrative embodiment of the invention is shown in FIG. 2, in the form of a hand-held portable wireless telephone instrument 50, i.e., a cellular phone. This has the advantages of being completely portable so that the user can take it with him or her to a hotel or meeting room to protect an area without any prior preparation, and also as there are no phone wires for an intruder to cut, the instrument cannot be defeated simply by cutting an outdoor telephone cable. Here, the cellular phone 50 is sitting in a recharger stand 52, which may contain some of the remote signalling features and sensors, such as fire or smoke detection. The cellular phone 50 here has a usual wireless-phone type keypad 54, with some of the keys (or combinations of keys being assigned functions such as alarm arm/disarm, panic button, silent/audible, etc. An infrared motion detector module 56 is positioned on the front of the cellular phone housing, as is an audible sounder 58. Other features, such as the ultra-sensitive microphone, are also present but are not illustrated here.

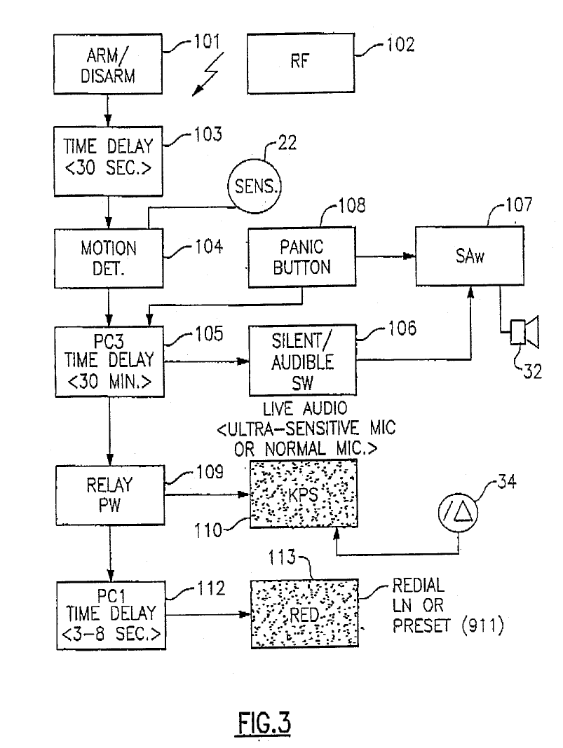

The intrusion alarm or anti-burglary feature of the invention is illustrated schematically in FIG. 3. First, a switch or key on the instrument 10, or a remote RF unit 102, actuates an ARM/DISARM relay 101, which has a brief time delay 103 on the order of thirty seconds. This permits the user enough time to clear the room after arming, without triggering an alarm. Thereafter, the system is ready, and the motion detector circuit 104, to which the IR motion 22 is connected, activates a time-limiting timer relay 105, which limits alarming of an event to some maximum time such as three minutes, after which the system shuts off unless motion is still being detected. If a silent/audible switch circuit 106 detects that audible alarming has been selected, then an alarm driver circuit 107 is actuated to drive the sounder 32. A panic button detector circuit 108 actuates both the alarm driver circuit 107 and the timer relay 105. The burglar alarm functionality generates a distinctive siren sound, i.e., a loud modulated “yelp”.

The timer relay 105 also activates timer relay 109, which in turn actuates an audio amplifier 110 connected with the ultra-sensitive microphone 34 (or is alternatively coupled to the normal mouthpiece microphone of the receiver or handset 12), to turn on the microphone for live-audio monitoring. The relay 109 also activates a time-delay relay 112, which after a brief period (e.g., three to eight seconds) actuates a redial functionality 113, which dials the last number dialed or else dials a preset number selected by the user, e.g., “9-1-1”. The time delay gives the user a brief period to override the automatic dial feature.

When an intrusion is detected, e.g., by the IR motion sensor or by the user pressing the “panic button,” the alarm 32 is sounded (unless silent monitoring has been selected), and after the brief 3- to 8-second delay, the telephone instrument automatically dials to the last number dialed. This can be the user's office, or the home of a neighbor or relative, or alternatively it may be the number of an emergency response office, such as police or fire department. After the number is dialed, the called party who answers the call will hear the burglar alarm tone, and will also be able to hear any “live audio” which may be sounds or speech made by the intruder(s) and overheard by the microphone 34. Most favorably, the called party will have a Caller ID functionality, and will recognize the identity and location of the emergency. The instrument 10 can be configured to default to a second number if there is no answer after some preset number of rings at the number that is dialed, e.g., to default to “9-1-1”.

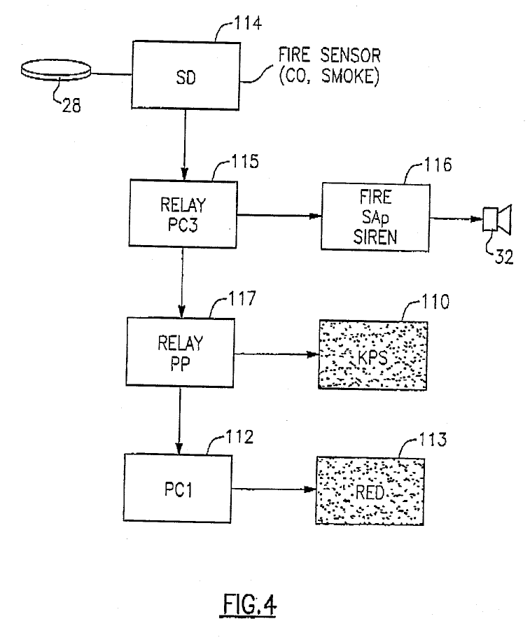

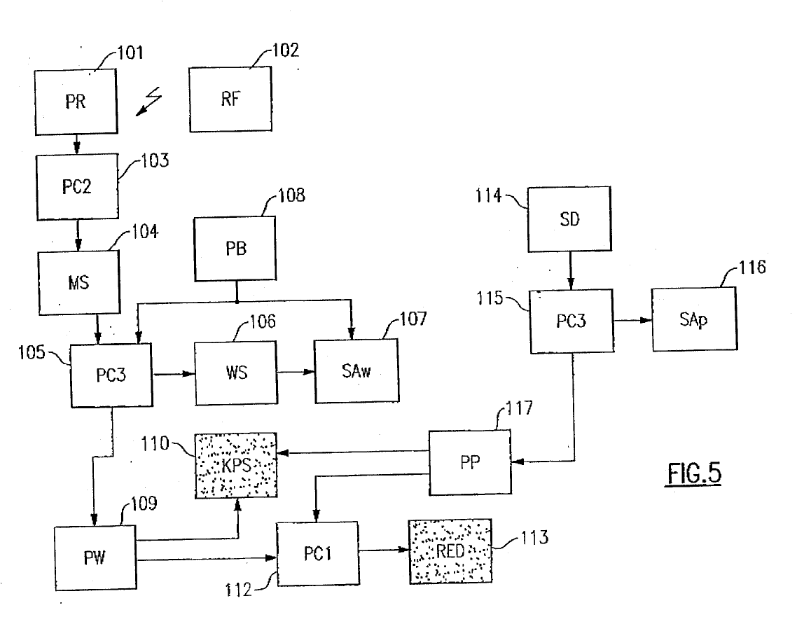

FIG. 4 illustrates the fire alarm functionality, and as mentioned before, this functionality is in ready or standby mode at all times and cannot be disabled or shut off. A fire sensor circuit 114 is connected with the smoke or fire detector 28, and if an alarm condition is detected, this circuit 114 turns on a relay switch 115, which turns on a fire alarm driver circuit 116 and also actuates a fire protection relay 117. This driver circuit 116 actuates the sounder 32 with a constant loud tone signal which is distinct from the burglar alarm audio signal. The signal from the fire protection relay 117 is applied to turn on the ultra-sensitive microphone circuitry 110, and also actuates the time delay relay 112, which actuates the redialer feature 113 after a brief time delay, in the same manner as discussed in respect to FIG. 3. For the fire alarming function, the siren or sounder does not have a silencer or cut-off feature, and cannot be deactivated.

In the event that a fire or similar emergency is detected, the alarm comes on and the instrument 10 automatically dials to the number selected by the user. The called party upon answering will hear the audible alarm over the phone line, and if the called party has a Caller ID feature, that party will be able to identify the location of the emergency. Again, as with the prior description of FIG. 3, if there is no answer after some predetermined number of rings, the instrument can dial a second or default number, such as “9-1-1”.

FIG. 5 illustrates both the above functionalities of FIG. 3 and FIG. 4 as they would be combined. The elements described earlier are identified with the same reference numbers, and a description of them need not be repeated here.

In another embodiment, all the sirens, and the IR motion sensor and fire sensor can be located within the housing 20 of the instrument. However, external sensors may be employed instead of, or in addition to, some or all of these. Other external sensors that may be employed would include sensors for carbon monoxide, other toxic vapors, particulate levels, extreme pressure situations, high or low temperatures, and flood detection. This is not an exhaustive list. Either system could be used for the protection of very young or elderly persons.

In the cellular phone embodiment 50, the use of the panic button makes the phone a personal portable alarm system, both sounding an audible alarm and automatically dialing for assistance. The cellular phone embodiment 50, if equipped with a vibration or inertial motion detector, can also be used to protect a vehicle from theft. If the unit is left in a vehicle, and is set to “armed” then it will automatically notify the user of any unauthorized movement of the vehicle. The cellular phone makes it possible to track the position of the vehicle as well. Thus, this system also increases both the probability of recovery of a stolen vehicle and the speed with which it is recovered.

The cellular phone version 50 can also be used for protection of a hotel room, with the user leaving the unit armed in the room, perhaps concealed behind or under some item, and then pre-dialing to the number of the location where he or she is going to be. Alternatively, the user can pre-dial to a second cellular phone or to a pager which he or she has in his or her possession.

While the invention is described in reference to preferred embodiments, the invention is certainly not limited to those embodiments. Rather, many modifications and variation would present themselves to persons skilled in the art without departing from the scope and spirit of the invention, as defined in the appended claims.

I claim:

1. A telephone instrument that is adapted both for making and receiving telephone calls, and also for emergency alarming and automatic dialing to a predetermined telephone number in the event that an alarm situation is detected; comprising a housing; dial pad means in the housing for dialing to make an outgoing call, the dial pad means including means permitting the user to select a number for automatic dialing; receiver means including a voice pickup and a speaker for picking up a user's voice and providing an audible voice signal to the user during a telephone conversation; an emergency condition sensor mounted on the housing; and means within the housing for automatically dialing the number selected by the user after said emergency condition sensor detects that said emergency condition exists.

2. The telephone instrument of claim 1 wherein said emergency condition sensor includes a motion sensor for detecting the presence of an intruder in an area in which the telephone instrument is located.

3. The telephone instrument of claim 1 wherein said instrument is a portable cellular phone.

4. The telephone instrument of claim 1 further comprising an ultra-sensitive microphone and means for actuating same when said sensor detects an emergency condition.

5. The telephone instrument of claim 4 further comprising an alarm sounder within said housing, and means for actuating said sounder after the sensor detects that said emergency condition exists.

6. The telephone instrument of claim 1 further comprising an additional sensor for detecting a second emergency condition, and means connecting with said means for automatically dialing, so that said instrument automatically dials said selected number when said additional sensor detects that said second emergency condition exists.

7. The telephone instrument of claim 5 further comprising an additional sensor for detecting a second emergency condition, and means connecting with said means for automatically dialing, so that said instrument automatically dials said selected number when said additional sensor detects that said second emergency condition exists, and means for actuating said sounder after said second sensor detects that said second emergency condition exists.

8. The telephone instrument of claim 7 wherein said sounder emits two distinct audible sounds, one when said first condition is detected and the other when said second condition is detected.

9. The telephone instrument of claim 5, further comprising means for selectively disabling said alarm sounder to permit the user to select a silent alarm mode in which the instrument dials to the selected number, but does not alert an intruder that the emergency condition has been detected.

10. The telephone instrument of claim 5, further including a panic button feature including means for accepting manual actuation by the user, and means connected therewith for actuating the automatic dialing means and said alarm sounder.
